(19) United States
(12) Patent Application Publication
(10) Pub. No.: US 2013/0335949 A1
(43) Pub. Date: Dec. 19, 2013

(54) LIGHTING DEVICE HAVING AT LEAST ONE WATER-ACTIVATED BATTERY MOUNTED BETWEEN A BOTTLE CAP AND A BOTTLE

(71) Applicant: SUENG-NIEN KAO, TAIPEI (TW)

(72) Inventor: SUENG-NIEN KAO, TAIPEI (TW)

(73) Assignee: KIN TEC TECHNOLOGY CORPORATION, TAIPEI CITY (TW)

(21) Appl. No.: 13/524,050

(22) Filed: Jun. 15, 2012

(51) Int. Cl. F21V 33/00

(52) U.S. Cl. 362/101

(57) ABSTRACT

A lighting device has a bottle, a bottle cap and at least one water-activated battery The bottle cap is mounted on the bottle and includes a light module having a printed circuit board (PCB) and a light source. The light source is mounted to a top surface of the PCB. The at least one water-activated battery is mounted between the bottle cap and the bottle and includes a top end and a bottom end. The top end is connected to the PCB via contacts. The bottom end is disposed in the bottle. In use, the bottle is filled with water to make the water-activated battery soaked in the water. The constituents of the water-activated battery then chemically react to generate electricity to supply power to the light source. Therefore, the bottle can be reused.

### BACKGROUND OF THE INVENTION

1. Field of the Invention

The present invention relates to a lighting device, and more particularly to a lighting device that reuses a plastic bottle and uses at least one water-activated battery to supply power for environmental protection.

2. Description of the Prior Arts

Plastic bottles are typically used to store liquids such as water, carbonated beverages and juices because they are lightweight and less expensive and provide good gas barrier properties and chemical resistance.

Although the plastic bottles have advantages as described above, the plastic bottles are not environmentally friendly. The plastic bottles cause a large amount of garbage after use. To reduce the amount of the plastic waste, recycling the plastic bottles for reuse is a useful solution. Therefore, how to reuse the used plastic bottles is an important issue.

To overcome the shortcomings, the present invention provides a lighting device having at least one water-activated battery mounted between a bottle cap and a bottle to mitigate or obviate the aforementioned problems.

### SUMMARY OF THE INVENTION

The main object of the present invention is to provide a lighting device that reuses a plastic bottle and uses at least one water-activated battery to supply power for environmental protection. To achieve the foregoing objective, the lighting device in accordance with the present invention comprises a bottle, a bottle cap and at least one water-activated battery. The bottle cap is mounted on the bottle and includes a light module having a printed circuit board (PCB) and a light source. The light source is mounted to a top surface of the PCB. The at least one water-activated battery is mounted between the bottle cap and the bottle and includes a top end and a bottom end. The top end is connected to the PCB via contacts. The bottom end is disposed in the bottle. In use, the bottle is filled with water to make the water-activated battery soaked in the water. The constituents of the water-activated battery then chemically react to generate electricity to supply power to the light source. Therefore, the bottle can be reused. In addition, the water-activated battery is environmentally friendly due to an absence of heavy metals.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a lighting device in accordance with the present invention;

FIG. 2 is a partially exploded perspective view of the first embodiment of the lighting device in FIG. 1;

FIG. 3 is an enlarged side view in partial section of the first embodiment of the lighting device in FIG. 1;

FIG. 4 is an enlarged cross-sectional side view of a middle cap and a top cap of the first embodiment of the lighting device in FIG. 1;

FIGS. 5 and 6 are enlarged cross-sectional top views of the first embodiment of the lighting device in FIG. 1;

FIG. 7 is a partially exploded perspective view of a second embodiment of a lighting device in accordance with the present invention; and

FIG. 8 is an enlarged side view in partial section of the second embodiment of the lighting device in FIG. 7.

### DETAILED DESCRIPTION OF THE PREFERRED EMBODIMENTS

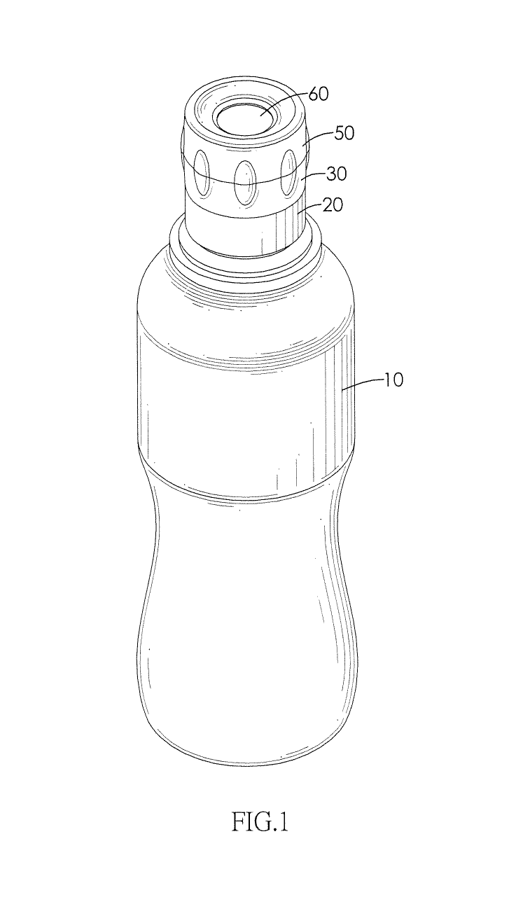

With reference to FIGS. 1 to 3, a lighting device in accordance with the present invention comprises a plastic bottle 10, a bottle cap and at least one water-activated battery 70.

The bottle 10 includes a neck having a top end, a mouth, an outer surface and external threads 11. The mouth is disposed at the top end of the neck. The external threads 11 are formed on the outer surface of the neck.

The bottle cap is mounted on the bottle 10 and includes a bottom cap 20, a middle cap 30, a light module 40, a top cap 50 and a lens 60. The bottom cap 20 seals the mouth of the bottle 10 and has a bottom annular sidewall 21, a top board 22, at least one mounting tube 23, a plurality of locking holes 24 and internal threads 25. The bottom annular sidewall 21 has an inner surface and a top portion. The at least one mounting tube 23 is formed on the top board 22 and extends downward therefrom. The locking holes 24 are formed through the top portion of the bottom annular sidewall 21. The internal threads 25 are formed on the inner surface of the bottom annular sidewall 21 for engagement with the external threads 11 on the bottle 10.

The middle cap 30 is disposed above the bottom cap 20 and has a middle annular sidewall 31, a bottom board 32, a plurality of locking projections 33 and a plurality of positioning grooves 34. The middle annular sidewall 31 has a top portion and a bottom portion. The locking projections 33 extend inward from an inner surface of the bottom portion of the middle annular sidewall 31 and engage the locking holes 24 of the bottom cap 20. The positioning grooves 34 are formed in an outer surface of the top portion of the middle annular sidewall 31 and each positioning groove 34 is inverted T-shaped and has a longitudinal portion 341 and a lateral portion 342. The lateral portion 342 extends from and communicates with a bottom of the longitudinal portion 341 and has a first side 3421 and a second side 3421′.

The light module 40 is mounted in the middle cap 30 and has a printed circuit board (PCB) 41, a light source 42 and a switch 43. The PCB 41 is secured to a top surface of the bottom board 32 of the middle cap 30 and has a top surface and a plurality of slots 411. The slots 411 are formed through the PCB 41 for engaging snap tabs 321 extending from the top surface of the bottom board 32 of the middle cap 30. The light source 42 is a light emitting diode (LED) and is mounted to a center of the top surface of the PCB 41. The switch 43 is mounted to a periphery of the top surface of the PCB 41 and has a movable part 431. The movable part 431 can be moved to turn the light source 42 either on or off.

The top cap 50 is disposed above the middle cap 30 and has a top annular sidewall 51, a top board 52, an aperture 53, a first push block 54, a second push block 55 and a plurality of positioning projections 56. The top annular sidewall 51 has a bottom portion. The top board 52 has a bottom surface and a center. The aperture 53 is formed through a center of the top board 52 and corresponds to the light source 42. The first push block 54 and the second push block 55 extend downward from a periphery of the bottom surface of the top board 52. The positioning projections 56 extend inward from an inner surface of the bottom portion of the top annular sidewall 51. The positioning projections 56 are disposed into the longitudinal portions 341 of the positioning grooves 34 of the middle cap 30 and the top cap 50 is then rotated to make the positioning projections 56 engage the first sides 3421 or the second sides 3421′ of the lateral portions 342 of the positioning grooves 34.

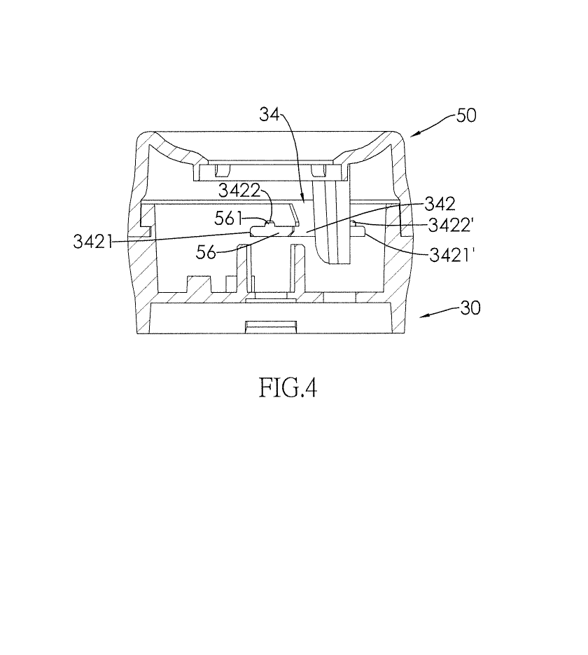

With reference to FIG. 4, in a preferred embodiment, the first side 3421 of the lateral portion 342 of at least one positioning groove 34 of the middle cap 30 has a first recess 3422 formed in a groove top surface thereof. The second side 3421′ of the lateral portion 342 of the at least one positioning groove 34 of the middle cap 30 has a second recess 3422′ formed in a groove top surface thereof At least one positioning projection 56 of the top cap 50 has a protrusion 561 extending from a top surface thereof and engaging the first recess 3422 or the second recess 3422′ of the positioning groove 34 of the middle cap 30.

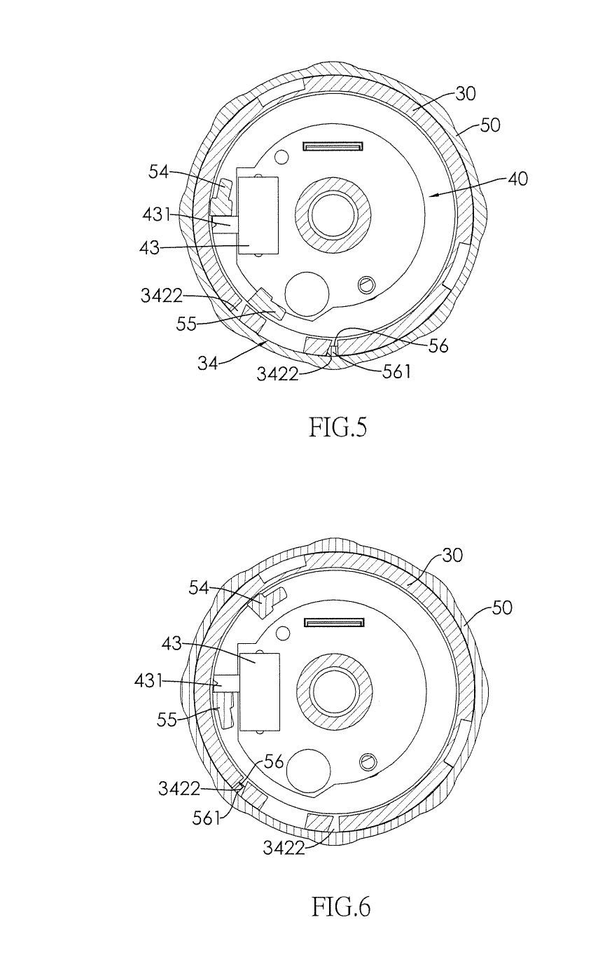

With reference to FIGS. 5 and 6, the top cap 50 is reciprocally rotated relative to the middle cap 30 to make the positioning projections 56 of the top cap 50 move along the lateral portions 342 of the positioning grooves 34 of the middle cap 30. When the protrusion 561 of the positioning projection 56 of the top cap 50 engages the first recess 3422 or the second recess 3422′ of the lateral portion 342, the first push block 54 or the second push block 55 of the top cap 50 pushes the movable part 431 of the switch 43. As a result, the light source 42 is switched on or off.

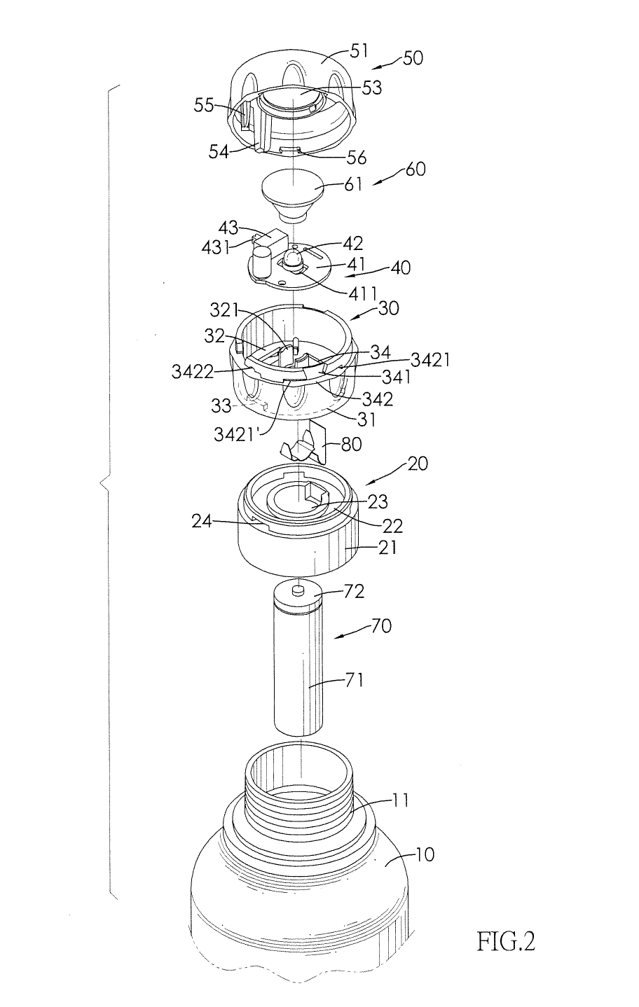

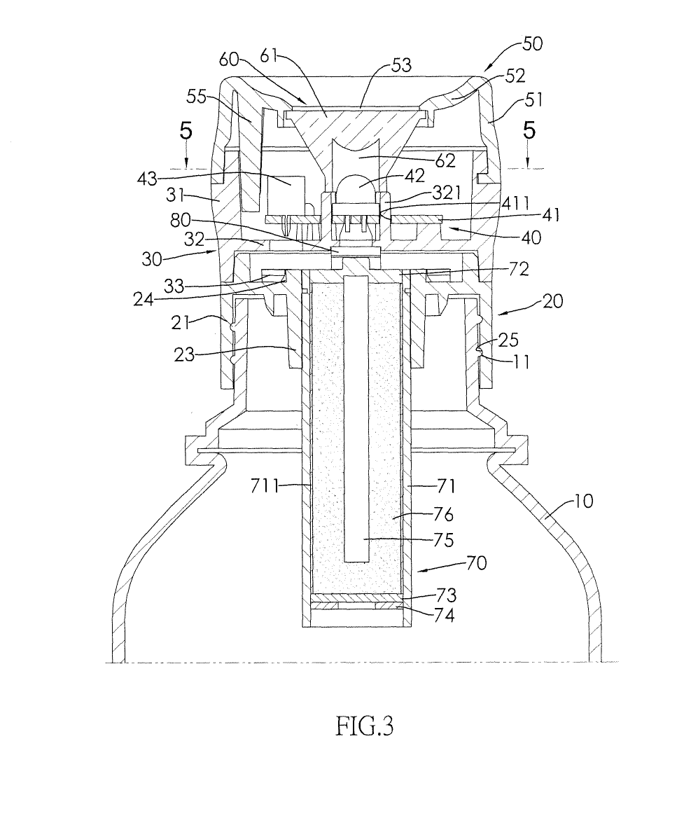

With reference to FIGS. 2 and 3, the lens 60 is cone-shaped, is disposed in the top cap 50 and has a top end, a bottom end, diameters, a plate 61 and a cavity 62. The diameters decrease progressively from the top end to the bottom end of the lens 60. The plate 61 is formed on the top end of the lens 60 and has a periphery secured to an edge of the aperture 53 of the top cap 50. The cavity 62 is formed in the bottom end of the lens 60 for receiving the light source 42.

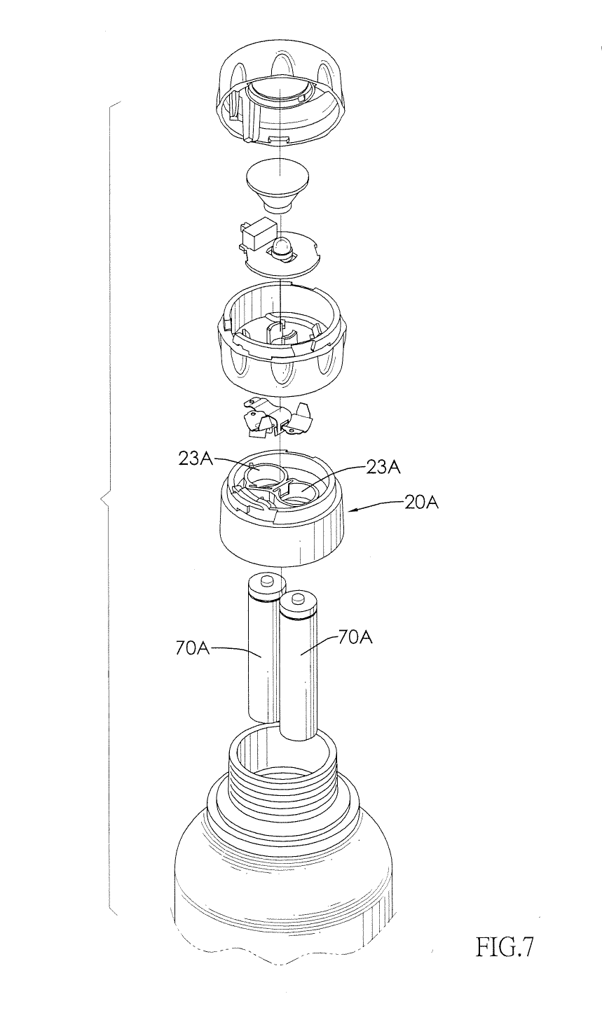

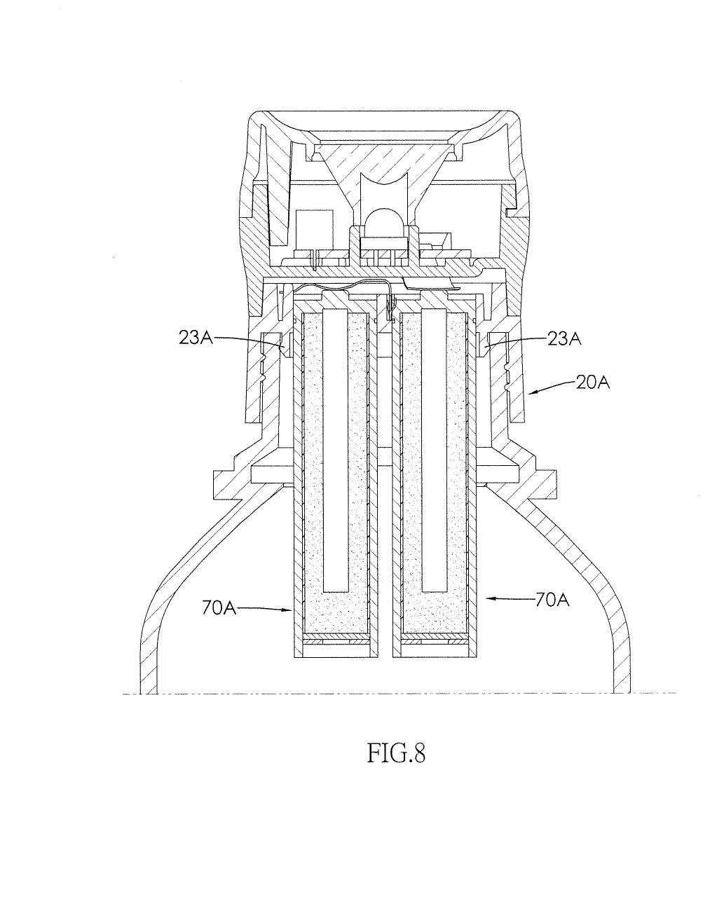

The at least one water-activated battery 70 is mounted between the bottle cap and the bottle 10 and includes a top end and a bottom end. The top end of the at least one water-activated battery 70 is mounted through the at least one mounting tube 23 of the bottom cap 20 and is connected to the PCB 41 via contacts 80 to supply power to the light source 42. The bottom end of the at least one water-activated battery 70 is disposed in the bottle 10. The number of the water-activated battery 70 is equal to the number of the mounting tube 23 of the bottom cap 20. With reference to FIGS. 2 and 3, in a first embodiment, the lighting device has one water-activated battery 70 and the bottom cap 20 has one mounting tube 23. With reference to FIGS. 7 and 8, in a second embodiment, the lighting device has two water-activated batteries 70A and the bottom cap 20A has two mounting tubes 23A.

With reference to FIG. 3, the at least one water-activated battery 70 includes a magnesium alloy can 71, a copper cap 72, an absorbent member 73, a retaining ring 74 and a carbon rod 75. The magnesium alloy can 71 is filled with an activated carbon 76 and has a top end, a bottom end, an inner surface and an isolation layer 711. The isolation layer 711 is attached to the inner surface of the magnesium alloy can 71. The copper cap 72 covers and seals the top end of the magnesium alloy can 71. The absorbent member 73 and the retaining ring 74 are mounted to the bottom end of the magnesium alloy can 71. The carbon rod 75 is disposed inside the magnesium alloy can 71 and is connected to the copper cap 72. The water-activated battery 70 is conventional and thus descriptions thereof will be omitted.

When the lighting device of the present invention is in use, the bottle 10 is filled with water to make the bottom end of the water-activated battery 70 soaked in the water. Water flows through the retaining ring 74 and the absorbent member 73 and penetrates the activated carbon 76. The constituents of the water-activated battery 70 then chemically react to generate electricity to supply power to the light source 42. The object of the present invention is to provide the lighting device that reuses a plastic bottle 10 and uses at least one water-activated battery 70 for environmental protection.

Even though numerous characteristics and advantages of the present invention have been set forth in the foregoing description, together with details of the structure and features of the invention, the disclosure is illustrative only. Changes may be made in the details, especially in matters of shape, size and arrangement of parts within the principles of the invention to the full extent indicated by the broad general meaning of the terms in which the appended claims are expressed.

What is claimed is:

1. A lighting device comprising:
a bottle;
a bottle cap mounted on the bottle and including a light module having:
a printed circuit board having a top surface; and
a light source mounted to the top surface of the printed circuit board; and
at least one water-activated battery mounted between the bottle cap and the bottle and including:
a top end connected to the printed circuit board via contacts; and
a bottom end disposed in the bottle.

2. The lighting device as claimed in claim 1, wherein
the bottle includes a neck having a mouth; and
the bottle cap includes
a bottom cap sealing the mouth of the bottle and having at least one mounting tube through which the top end of the at least one water-activated battery is mounted, and the number of the mounting tube being equal to the number of the water-activated battery; and
a middle cap disposed above the bottom cap and in which the light module is mounted.

3. The lighting device as claimed in claim 2, wherein
the light module has a switch mounted to the top surface of the printed circuit board and having a movable part; and
the bottle cap includes a top cap disposed above the middle cap and having:
a top board;
an aperture formed through the top board and corresponding to the light source; and
a first push block and a second push block extending downward from the top board, and the top cap being reciprocally rotatable relative to the middle cap to make the first push block or the second push block push the movable part of the switch to turn the light source on or off.

4. The lighting device as claimed in claim 3, wherein
the middle cap has
a middle annular sidewall having a top portion; and
a plurality of positioning grooves formed in an outer surface of the top portion of the middle annular sidewall and each positioning groove having:
a longitudinal portion; and
a lateral portion extending from and communicating with a bottom of the longitudinal portion and having a first side and a second side; and
the top cap has
a top annular sidewall having a bottom portion; and
a plurality of positioning projections extending from an inner surface of the bottom portion of the top annular sidewall, the positioning projections disposed into the longitudinal portions of the positioning grooves of the middle cap and the top cap being then rotated to make the positioning projections engage the first sides or the second sides of the lateral portions of the positioning grooves and to make the first push block or the second push block of the top cap push the movable part of the switch.

5. The lighting device as claimed in claim 4, wherein
the first side of the lateral portion of at least one positioning groove of the middle cap has a first recess formed in a groove top surface thereof;
the second side of the lateral portion of the at least one positioning groove of the middle cap has a second recess formed in a groove top surface thereof; and
at least one positioning projection of the top cap has a protrusion extending from a top surface thereof and engaging the first recess or the second recess of the positioning groove of the middle cap.

6. The lighting device as claimed in claim 5, wherein
the bottom cap has a bottom annular sidewall having:
a top portion; and
a plurality of locking holes formed through the top portion of the bottom annular sidewall; and
the middle cap has a plurality of locking projections extending from an inner surface of a bottom portion of the middle annular sidewall and engaging the locking holes of the bottom cap.

7. The lighting device as claimed in claim 3, wherein the bottle cap includes a lens disposed in the top cap and having:
a top end;
a bottom end;
a plate formed on the top end of the lens and having a periphery secured to an edge of the aperture of the top cap; and
a cavity formed in the bottom end of the lens for receiving the light source.

8. The lighting device as claimed in claim 4, wherein the bottle cap includes a lens disposed in the top cap and having:
a top end;
a bottom end;
a plate formed on the top end of the lens and having a periphery secured to an edge of the aperture of the top cap; and
a cavity formed in the bottom end of the lens for receiving the light source.

9. The lighting device as claimed in claim 5, wherein the bottle cap includes a lens disposed in the top cap and having:
a top end;
a bottom end;
a plate formed on the top end of the lens and having a periphery secured to an edge of the aperture of the top cap; and
a cavity formed in the bottom end of the lens for receiving the light source.

10. The lighting device as claimed in claim 6, wherein the bottle cap includes a lens disposed in the top cap and having:
a top end;
a bottom end;
a plate formed on the top end of the lens and having a periphery secured to an edge of the aperture of the top cap; and
a cavity formed in the bottom end of the lens for receiving the light source.

11. The lighting device as claimed in claim 6, wherein
the neck of the bottle has external threads formed on an outer surface thereof; and
the bottom cap has internal threads formed on an inner surface of the bottom annular sidewall for engagement with the external threads on the bottle.

12. The lighting device as claimed in claim 1, wherein the light source is a light emitting diode.

13. The lighting device as claimed in claim 2, wherein the light source is a light emitting diode.

14. The lighting device as claimed in claim 3, wherein the light source is a light emitting diode.

15. The lighting device as claimed in claim 4, wherein the light source is a light emitting diode.

16. The lighting device as claimed in claim 5, wherein the light source is a light emitting diode.

17. The lighting device as claimed in claim 1, wherein the at least one water-activated battery includes
a magnesium alloy can filled with an activated carbon and having:
a top end;
a bottom end;
an inner surface; and
an isolation layer attached to the inner surface of the magnesium alloy can;
a copper cap covering and sealing the top end of the magnesium alloy can;
an absorbent member and a retaining ring mounted to the bottom end of the magnesium alloy can; and
a carbon rod disposed inside the magnesium alloy can and connected to the copper cap.

18. The lighting device as claimed in claim 2, wherein the at least one water-activated battery includes
a magnesium alloy can filled with an activated carbon and having:
a top end;
a bottom end;
an inner surface; and
an isolation layer attached to the inner surface of the magnesium alloy can;
a copper cap covering and sealing the top end of the magnesium alloy can;
an absorbent member and a retaining ring mounted to the bottom end of the magnesium alloy can; and
a carbon rod disposed inside the magnesium alloy can and connected to the copper cap.

19. The lighting device as claimed in claim 3, wherein the at least one water-activated battery includes
a magnesium alloy can filled with an activated carbon and having:
a top end;
a bottom end;
an inner surface; and
an isolation layer attached to the inner surface of the magnesium alloy can;
a copper cap covering and sealing the top end of the magnesium alloy can;
an absorbent member and a retaining ring mounted to the bottom end of the magnesium alloy can; and
a carbon rod disposed inside the magnesium alloy can and connected to the copper cap.

20. The lighting device as claimed in claim 4, wherein the at least one water-activated battery includes
a magnesium alloy can filled with an activated carbon and having:
a top end;
a bottom end;
an inner surface; and
an isolation layer attached to the inner surface of the magnesium alloy can;
a copper cap covering and sealing the top end of the magnesium alloy can;
an absorbent member and a retaining ring mounted to the bottom end of the magnesium alloy can; and
a carbon rod disposed inside the magnesium alloy can and connected to the copper cap.
